(19) United States
(12) Patent Application Publication
(10) Pub. No.: US 2018/0200652 A1
(43) Pub. Date: Jul. 19, 2018

(54) Filter Element With Offset Fluid Passage

(71) Applicant: Baldwin Filters, Inc., Kearney, NE (US)

(72) Inventors: Steven J. Merritt, Kearney, NE (US); Nicholas R. Peterson, Ellington, CT (US); Robert H. Volk, Broad Brook, CT (US)

(21) Appl. No.: 15/408,909

(22) Filed: Jan. 18, 2017

(51) Int. Cl. B01D 29/21; B01D 35/00; B01D 36/00; F02M 37/22

(52) U.S. Cl. CPC B01D 29/21; B01D 35/005; B01D 2201/291; F02M 37/221; B01D 2201/316; B01D 36/001

(57) ABSTRACT

A filter element has a ring of a first filter medium disposed between upper and lower end caps. A center tube extends between the upper and lower end caps radially inwards of the first filter medium. Holes in the center tube, adjacent the upper end cap, allow fluid to pass through the center tube towards a separator tube. The separator tube contains a second filter medium that strips water from the fluid into a fluid reservoir below the lower end cap. A radially offset duct defining a fluid passage extends from below the lower end cap to above the upper end cap.

### BACKGROUND OF THE DISCLOSURE

The present disclosure relates to filters, and more particularly, to a two stage filter element with a structure for removing air from fuel flow for use in a fuel supply system for a motor vehicle.

Significant quantities of contaminants such as water and assorted abrasive particles may be found in fuel. To remove contaminants and prevent damage to sensitive engine components, fuel supply systems may include one or more filter assemblies configured to remove water and contaminants from the fuel supply. Filter assemblies may incorporate a filter cartridge with a housing that is disposed along with the filter element after a pre-determined period of use. Alternatively, filter assemblies may employ a permanent housing with a cover that permits access to a removable filter element that is replaced at regular service intervals. In either form, the filter assembly defines a fuel flow path routing fuel through filter media supported by the filter element before the fuel is delivered to sensitive engine systems. Some filter assemblies incorporate structures to coalesce and separate water that is present in fuel from fuel that will be delivered to the engine. Separated water is accumulated and removed from the filter assembly.

The process of opening the filter housing and replacing a spent filter element results in a large amount of air in the filter housing, which must be displaced by fuel for proper operation of the filter assembly and downstream fuel delivery components such as high pressure pumps. Filter assemblies commonly incorporate a path that allows air to escape the filter housing as the housing is filled with fuel after a service event.

Prior art disclosing one embodiment of a single-stage filter element with a structure for removing air from a filter housing is presented in FIGS. 1 and 2.

There is a need in the art for a filter element that cooperates with a filter housing to provide filtration of both particulates and separation of water, and that can provide an escape path for air trapped within the filter housing.

### SUMMARY

A filter element in accordance with aspects of the present disclosure generally has a central filter axis and comprises an upper end cap, a lower end cap, and a ring of first filter medium coaxial with the filter axis. The first filter medium is secured between the upper and lower end caps. The upper end cap defines an aperture radially spaced from the filter axis. The upper end cap includes structures projecting from the periphery to engage complementary structures on the filter cover.

The generally cylindrical first filter medium is secured to the lower end of said upper end cap and extends axially towards and secures to the lower end cap. Fuel flows through the first filter medium from outside the circumference and particles separate from the fuel as it flows through the filter element and the particles are retained in the filter media.

A center tube extends between the upper and lower end caps radially inwards of the first filter medium. The center tube contains ribs that direct fluid flow towards holes in the center tube adjacent the upper end cap. The center tube is secured to both the upper and lower end caps.

A separator tube extends from the upper end cap towards the lower end cap, radially inwards of the center tube. The separator tube includes a cylindrical frame that supports a second filter medium. The second filter medium separates coalesced droplets of water from the fuel. Radial fins extend from the separator tube. The fins center the separator tube within the center tube to facilitate mating the filter element with the standpipe.

The separator tube, center tube, and first filter medium are secured to the upper end cap in an annular cradle defined by the upper end cap. The center tube and first filter medium are secured to the lower end cap in an annular cradle defined at the inner radius by the lower end cap and at the outer radius by a bottom plate.

A duct defining a fluid passage extends from the aperture in the upper end cap to the lower end cap radially outwards of the center tube. The duct allows fluid to flow from a position above the upper end cap to a fluid reservoir between the lower end cap and the bottom plate.

### BRIEF DESCRIPTION OF THE DRAWINGS

Aspects of the preferred embodiment will be described in reference to the drawings, where like numerals refer to like elements:

FIG. 1 is a top plan view of a prior art filter element;

FIG. 2 is a side sectional view along parting line A-A of the prior art filter element of FIG. 1;

FIG. 3 is side sectional view of a filter element of the present disclosure within a filter housing and a filter cover;

FIG. 4 is a side view of the filter element of FIG. 3, with the first filter medium omitted for clarity;

FIG. 5 is a side sectional view of the filter element of FIG. 3;

FIG. 6 is a side sectional view of the upper end cap of the filter element of FIG. 3;

FIG. 7 is a side sectional view of the lower end cap of the filter element of FIG. 4;

FIG. 8A is a side view of the center tube of the filter element of FIG. 3;

FIG. 8B is an alternate side view, rotated 90 degrees about filter axis A-A relative to the side view of FIG. 8A, of the center tube of the filter element of FIG. 3;

FIG. 9 is a side sectional view of an alternate embodiment of a filter element of the present disclosure;

FIG. 10 is an isometric sectional partial view of the filter element of FIG. 9 depicting the connection between the separator tube and the lower end cap in detail;

FIG. 11 is a side sectional view of an alternate embodiment of a filter element of the present disclosure;

FIG. 12 is a side sectional view of an alternate embodiment of a filter element of the present disclosure;

FIG. 13 is a side sectional view of the upper end cap of the filter element of FIG. 11;

FIG. 14 is a side sectional view of the upper end cap of the filter element of FIG. 12;

FIG. 15 is a side sectional view of an alternate embodiment of the lower end cap of FIG. 7;

FIG. 16 is a side sectional view of an alternate embodiment of a filter element of the present disclosure;

FIG. 17 is an isometric view of the grommet of FIG. 16;

FIG. 18 is a side section view of the grommet of FIG. 16; and

FIG. 19 is a side sectional view of the filter element of FIG. 16 installed on a standpipe.

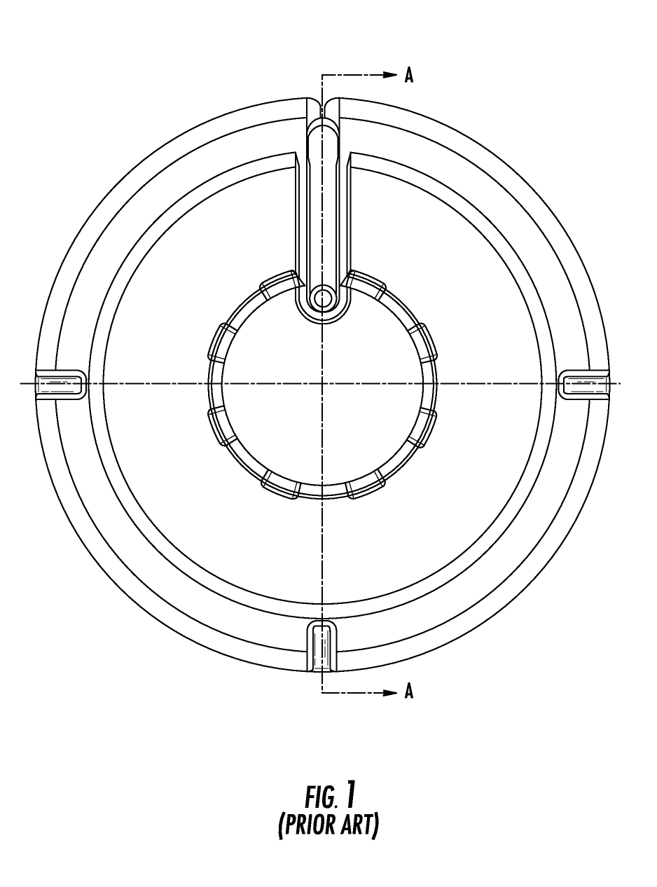

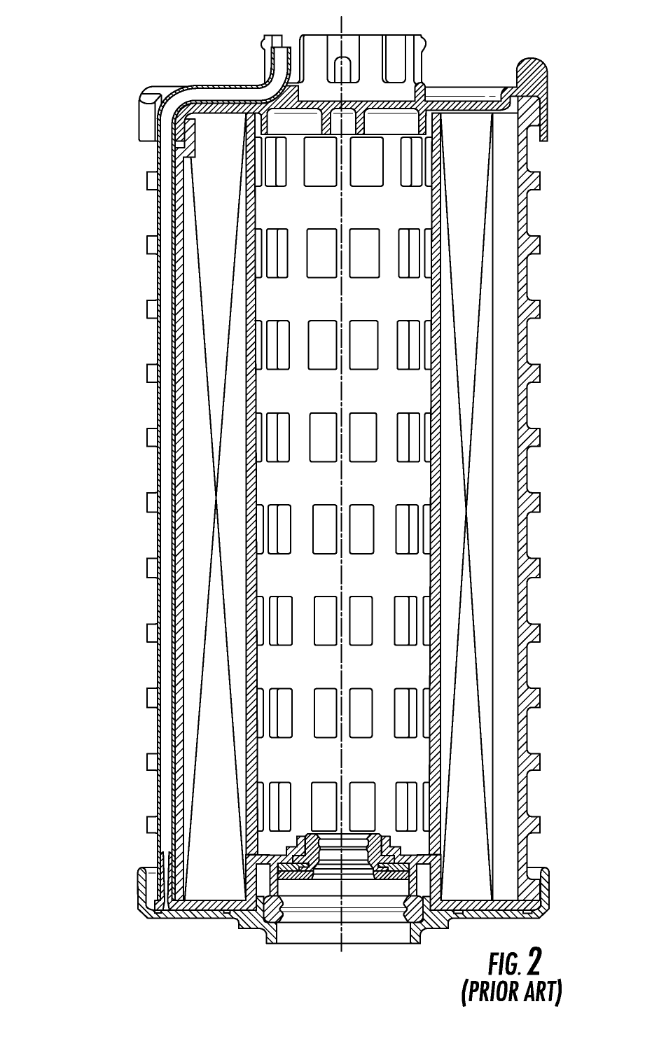

### DETAILED DESCRIPTION

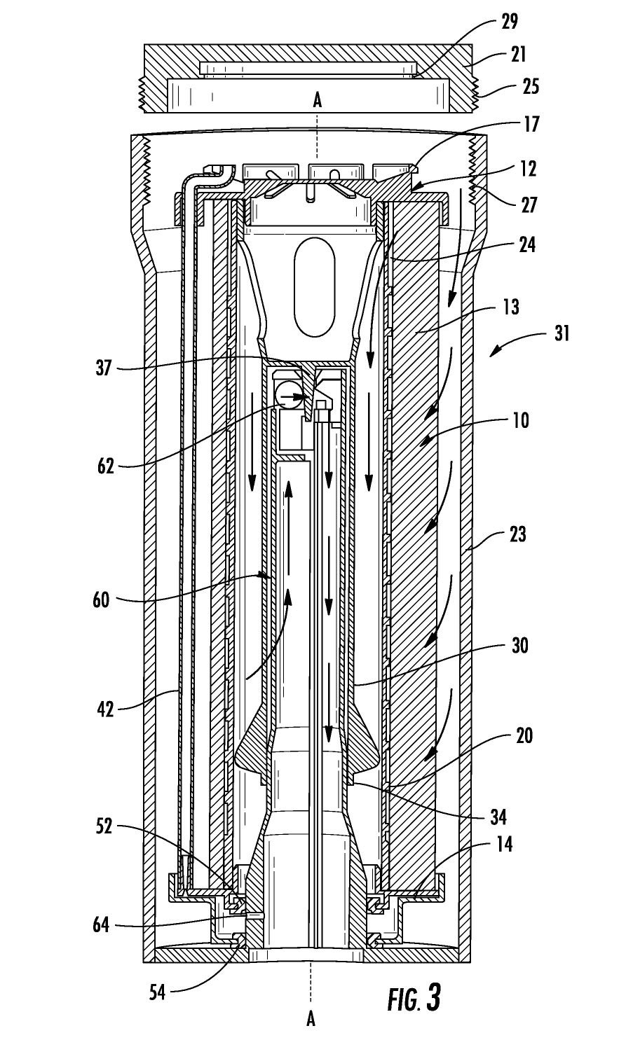

With reference to FIGS. 3-7, wherein like numerals represent similar parts throughout the several figures, a first embodiment of a replaceable filter element is generally designated by the reference numeral 10.

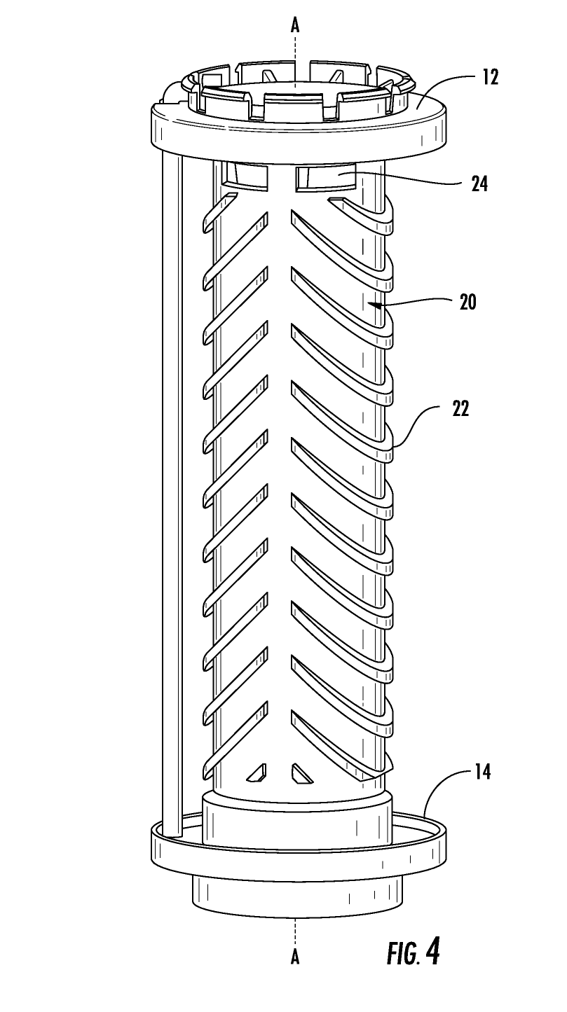

The filter element 10 includes structures for filtration of particles and separation of water from fuel flowing through the filter assembly 31. Referring to FIG. 3, the filter element 10 surrounds and seals against standpipe 60 of filter housing 23. A cover 21 is screwed or fastened onto filter housing 23 to secure filter element 10 within filter assembly 31. The arrows in FIG. 3 depict the basic fuel flow path through the filter element 10. During operation, incoming fuel passes through the first filter medium 13 radially from the outside to the inside of the first filter medium 13. The first filter medium 13 removes particles from the fuel and causes water suspended in the fuel to coalesce into droplets. The fuel then passes through holes 24 in the center tube 20 and then through the separator tube 30. The coalesced water droplets are stripped from the fuel by the second filter medium 39 (depicted in FIG. 5) and the filtered fuel flows through a ball valve 62 (depicted in FIG. 3) into a clean fuel path defined in standpipe 60. The ball valve 62 is held in an “open” position that permits fuel to flow out of the filter assembly towards the engine by a pin 37 when the filter element is installed.

Referring to FIG. 3, the filter element 10 mates with the standpipe 60 of the fuel supply system of a motor vehicle. Grommets 52, 54 surround drainage hole 64 in standpipe 60. When the filter element 10 is removed from the standpipe 60, the grommets 52, 54 no longer surround the drainage hole 64 and fluid in the housing 23 drains through drainage hole 64. When a new filter element 10 is installed on standpipe 60, the air trapped in the housing 23 flows through duct 42 as the filter element 10 fills with fuel.

The filter element 10 comprises an upper end cap 12 coaxial with a filter axis A-A. A ring of the first filter medium 13 extends between the upper end cap 12 and an opposing lower end cap 14. The first filter medium 13 is chosen from a suitably permeable, typically nonwoven fibrous material with pleats and fold lines normally running from one end cap to the other. The ends of the media are potted or sealed into the end caps using a potting material such as plastisol, urethane, hot melt or epoxy. Alternative methods of securing the end caps to the cylinder of filter media, such as heat staking, may also be employed. Generally, the filter element 10 and housing 23 cooperate to route fuel through the first and second filter media 13, 39 and prevent fuel from bypassing either media. The depicted first filter medium 13 is a pleated material, therefore the inner and outer diameters described reference the inner and outer tips of the pleats, respectively. The upper end cap 12 includes axially extending teeth 17 that form part of a snap fit connection securing the assembled filter element 10 to complementary structures 29 in the cover 21. The cover 21 engages housing 23 using threads 25, 27.

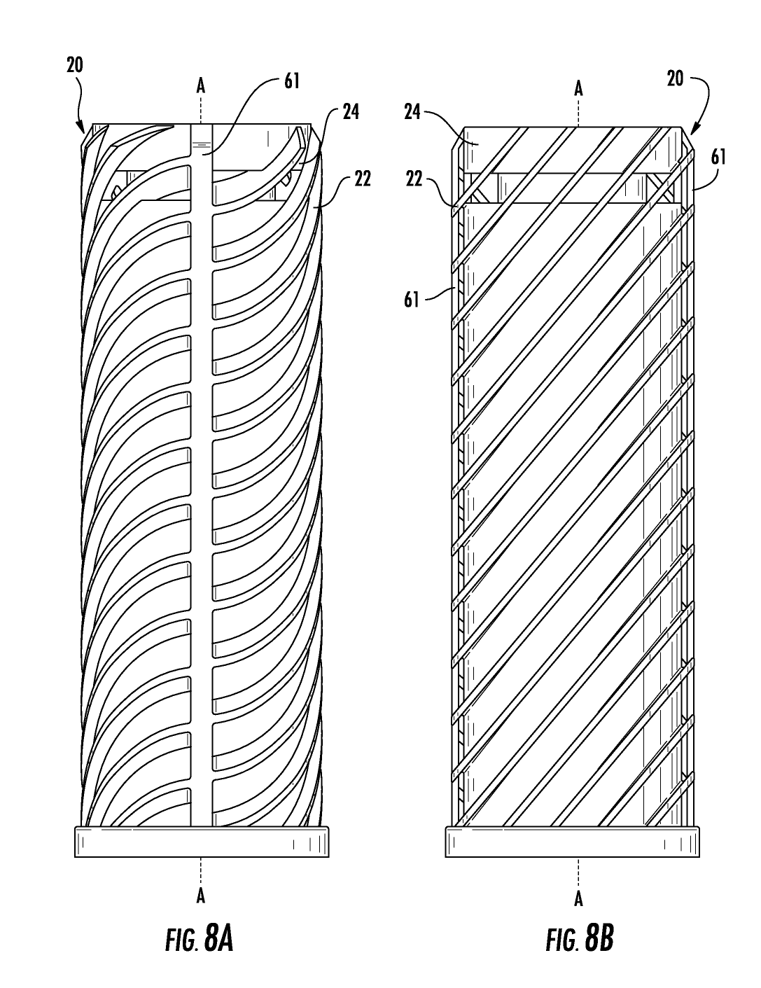

FIG. 4 depicts the filter element 10 without the first filter medium 13. The center tube 20 extends from the upper end cap 12 to the lower end cap 14. In the depicted embodiment, the center tube 20 is substantially sealed to each end cap. The center tube 20 is disposed radially inward of the first filter medium 13, and ribs 22 extend radially outwardly from an outside surface of the center tube 20. The ribs 22 (depicted in greater detail in FIGS. 8A and 8B) direct fluid towards the upper end cap 12 and provide support for the inner diameter of the first filter medium 13. Holes 24 in the center tube 20 adjacent the upper end cap 12 allow fluid to pass through the center tube 20. In the depicted embodiment, a plurality of holes 24 are spaced around the circumference of center tube 20.

Referring to FIG. 5, a separator tube 30 projects from the upper end cap 12 towards the lower end cap 14. The separator tube 30 defines an opening at a lower end 34, which mates with the outside surface of the standpipe 60 as shown in FIG. 3. In the depicted embodiment, the separator tube 30 is potted to the upper end cap 12 at an upper end 32 to provide a sealed connection. A cylindrical frame 36 near the lower end 34 of the separator tube 30 supports the second filter medium 39. In the depicted embodiment, the second filter medium 39 and the first filter medium 13 are in a concentric arrangement. The pin 37 extends along the filter axis A-A from a radial disc 35 of separator tube 30 towards the lower end cap 14.

The second filter medium 39 separates water from the fuel in the fluid flow path. In the depicted embodiment, the lower end of the separator tube 30 includes radially projecting fins 38. The fins 38 center and stabilize the separator tube 30 inside the center tube 20 to ensure proper mating with the standpipe 60 during installation of the filter element 10. In the depicted embodiment, the second filter medium 39 is mesh, although non-woven webs can be configured to serve this function. Droplets of water are unable to pass through the second filter medium 39 and fall towards the lower end cap 14 by the force of gravity.

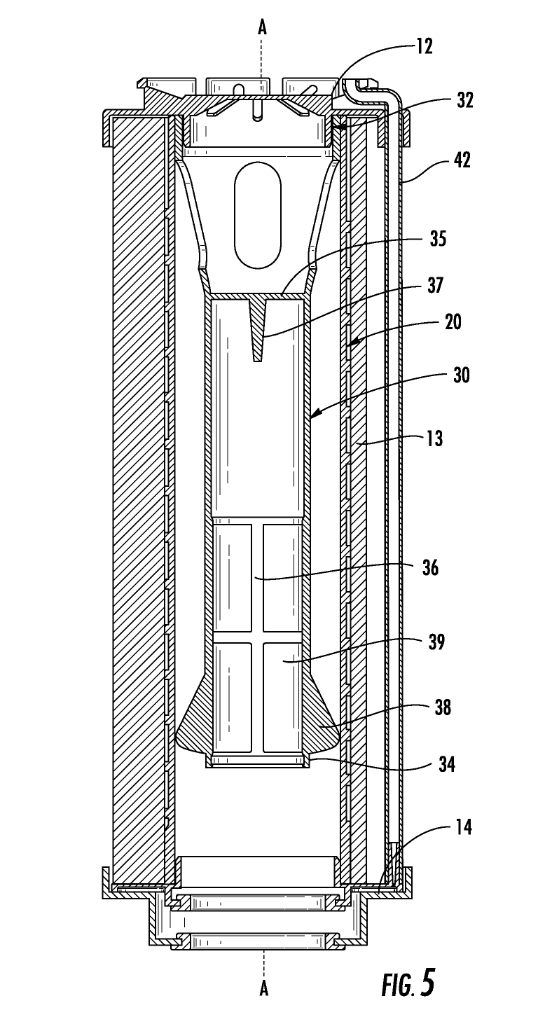

Referring to FIG. 6, the upper end cap 12 has a first (upper) surface 15 and a second (lower) surface 16. The upper end cap 12 projects radially from inner annular wall 11 to outer annular wall 18. The inner annular wall 11 and outer annular wall 18 define a cradle that can be filled with potting material, which seals the first filter medium 13 the center tube 20, and the separator tube 30 to the upper end cap 12. An aperture 19 extends through the upper end cap 12 from the first surface 15 to the second surface 16. A duct 42 defining a fluid passage extends from above the first surface 15 through the aperture 19.

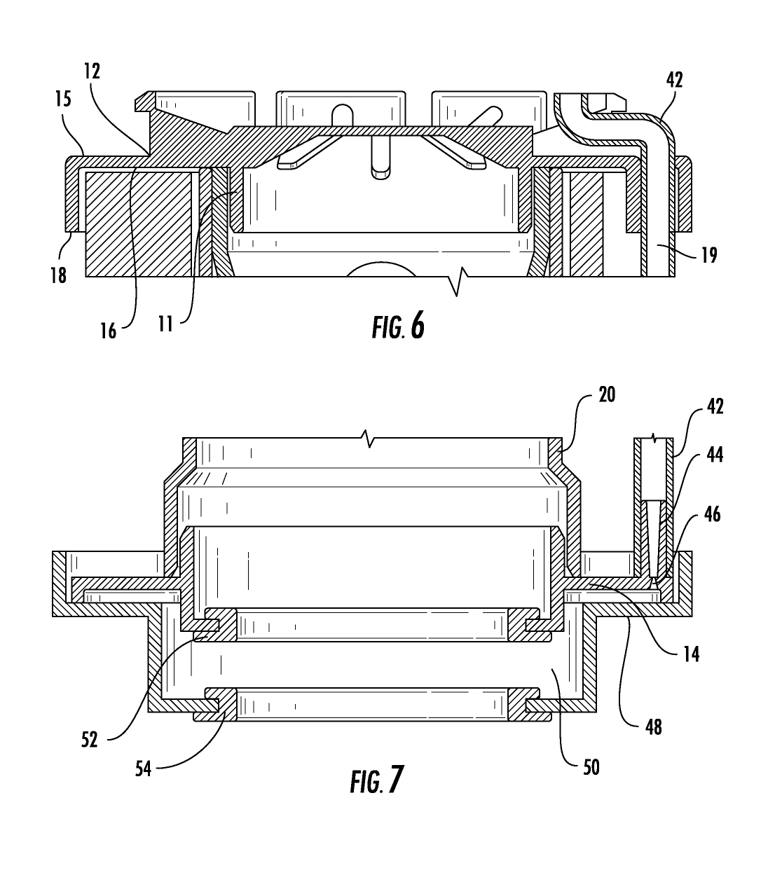

Referring to FIG. 7, the lower end of the duct 42 engages the lower end cap 14 at flow restrictor 44. In the depicted embodiment, flow restrictor 44 extends into the interior of the bottom end of the duct 42. Metering orifice 46 limits flow through duct 42. The lower end cap 14 is ultrasonically welded to bottom plate 48. In one embodiment, the lower end of the first filter medium 13 is potted within an annular cradle defined by the center tube 20 at an inner diameter and the bottom plate 48 at an outer diameter. This annular cradle radially spans lower end cap 14. In the embodiment depicted in FIG. 7, the inner end of the annular cradle is defined by a flange extending from the lower end cap 14. The flow restrictor 44 is integral with the lower end cap 14 and defines a restricted flow opening into a fluid reservoir 50 defined between lower end cap 14 and bottom plate 48. Grommets 52, 54 are axially spaced on the inner openings of the lower end cap 14 and bottom plate 48, respectively. The grommets 52, 54 seal against a standpipe 60 (depicted in FIG. 3) to contain the fluid reservoir 50 separate from the primary fluid flow path.

FIGS. 8A and 8B illustrate an alternative structure for a center tube compatible with some embodiments of the disclosed filter element. Ribs 22 extend from parting line 61 toward holes 24. The ribs 22 extend between identical parting lines 61 parallel to filter axis A-A directly opposite one another along the circumference of center tube 20. The ribs 22 are helically shaped adjacent parting lines 61 and extend linearly towards holes 24 between the helical sections. In the depicted embodiment, holes 24 extend the entire circumference of center tube 20 between parting lines 61 and ribs 22 extend axially over the holes 24. The structure of the center tube 20 allows the center tube to be molded as a single piece in a mold that separates radially at the parting lines.

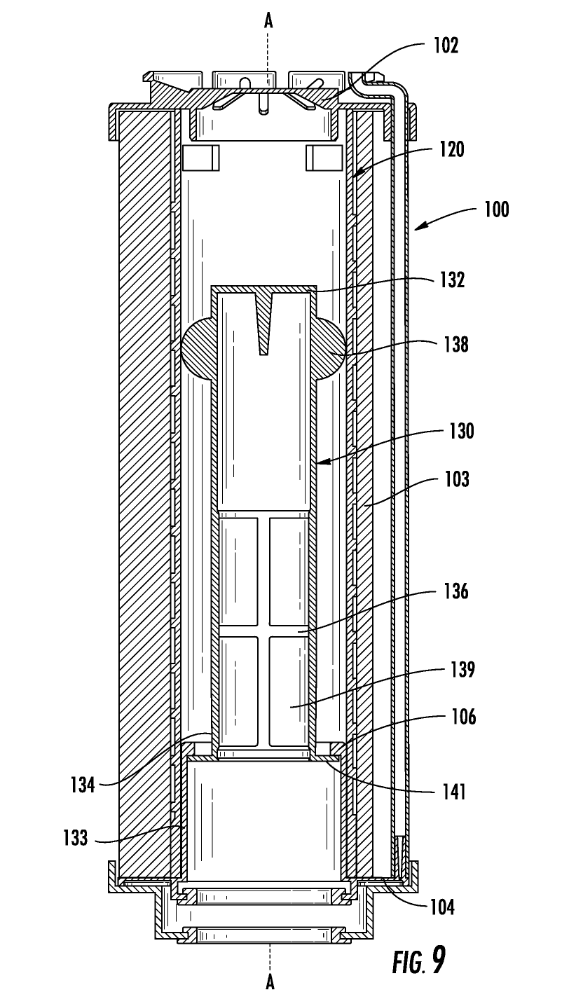

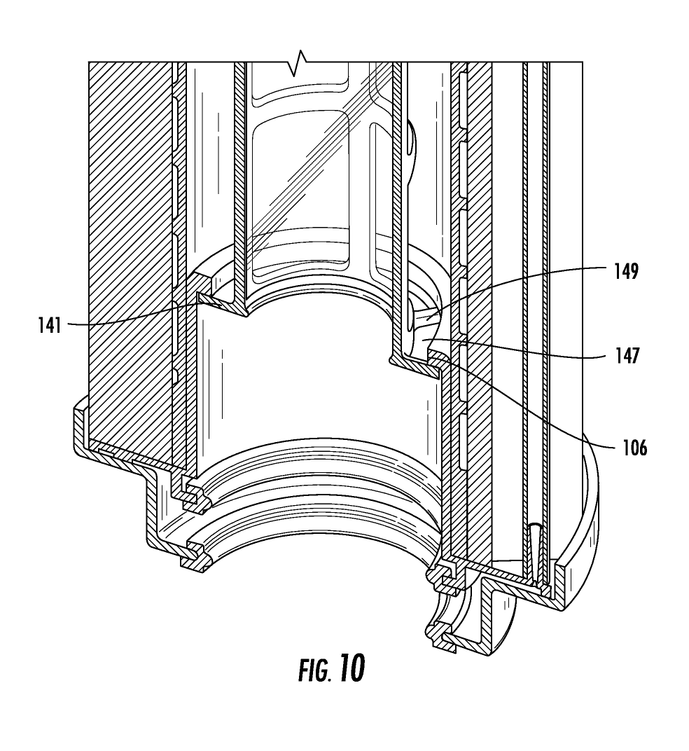

FIGS. 9 and 10 illustrate an alternative embodiment of a filter element 100 according to the disclosure. Filter element 100 is a two stage filter element for use in the filter housing 23 illustrated in FIG. 3. The structure and function of the two filter media 103, 139 are the same as discussed with respect to filter element 10 above. The interface between the filter element 100 and the filter housing 23 is also the same as discussed with reference to filer element 10 above. Discussion of filter element 100 will focus on where this embodiment differs from filter element 10 discussed above. Referring to FIGS. 9 and 10, a skirt 133 of the lower end cap 104 extends axially towards the upper end cap 102 radially inwards of center tube 120. The lower end cap skirt 133 terminates in a lip 106. The separator tube 130 extends from a lower end 134 to an upper end 132. A cylindrical frame 136 is located at the lower end 134 of separator tube 130. Fins 138 extend radially outwards of the separator tube 130 adjacent the upper end 132.

A lower flange 141 projects radially outwards from the separator tube 130 at lower end 134 and is bonded in a sealed relationship to the lower end cap 104 (depicted in FIG. 10). The lower flange 141 defines through holes 147 between radially projecting spoke-like supports 149. Through holes 147 permit separated water to descend through the flange 141. The design of the supports 149 and through holes 147 may vary depending on the application.

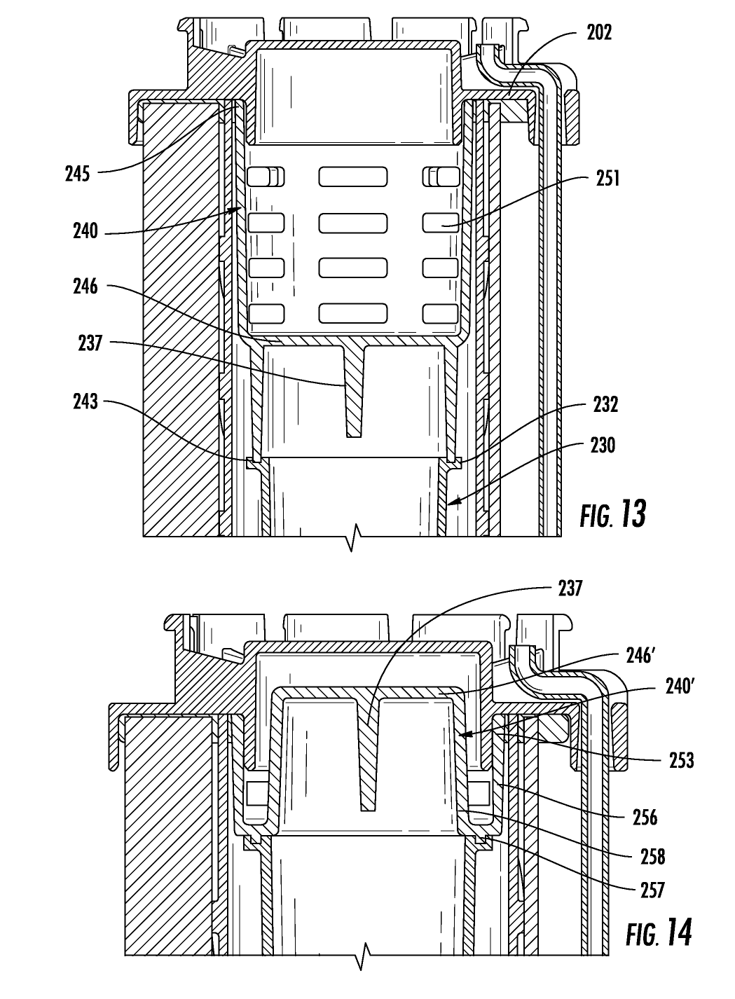

FIGS. 11 and 13 illustrate an alternative embodiment of a filter element 200 according to the disclosure. Discussion of filter element 200 will focus on where this embodiment differs from filter element 10 and 100 discussed above. The filter element 200 includes an axial spacer 240 extending from upper end cap 202, radially inwards of center tube 220, towards the lower end cap 204. The separator tube 230 extends from an upper end 232 to a lower end 234. A cylindrical frame 236 within the separator tube 230 is located adjacent the lower end 234 and supports the second filter medium 239. The second filter medium 239 separates water from the fuel in the fluid flow path.

Referring to FIG. 13, the axial spacer 240 extends from a lower end 243 to an upper end 245. The upper end 245 of the axial spacer 240 is potted to the upper end cap 202 and the lower end 243 of the axial spacer 240 is connected to the upper end 232 of the separator tube 230. A radial disc 246 is transversely disposed within the axial spacer 240 between the upper and lower ends 245, 243 of the axial spacer 240. A pin 237 extends from the radial disc 246 towards the lower end cap 243 of the axial spacer 240. Holes 251 above the radial disc 246 allow fluid to pass through the outer diameter of the axial spacer 240. In the depicted embodiment, both the pin 237 and the radial disc 246 are entirely solid and are formed as a unitary piece with the axial spacer 240 so that no fluid can pass through the radial disc 246 or pin 237. The axial spacer 240 may be modified in alternate embodiments to accommodate the same separator tube 230 within filters of various axial lengths.

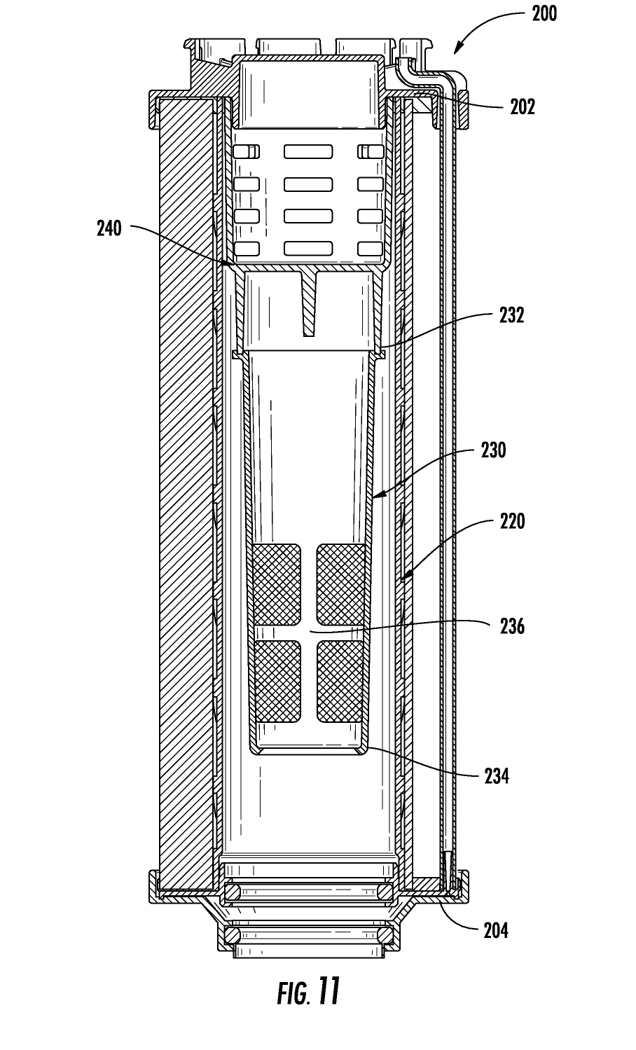

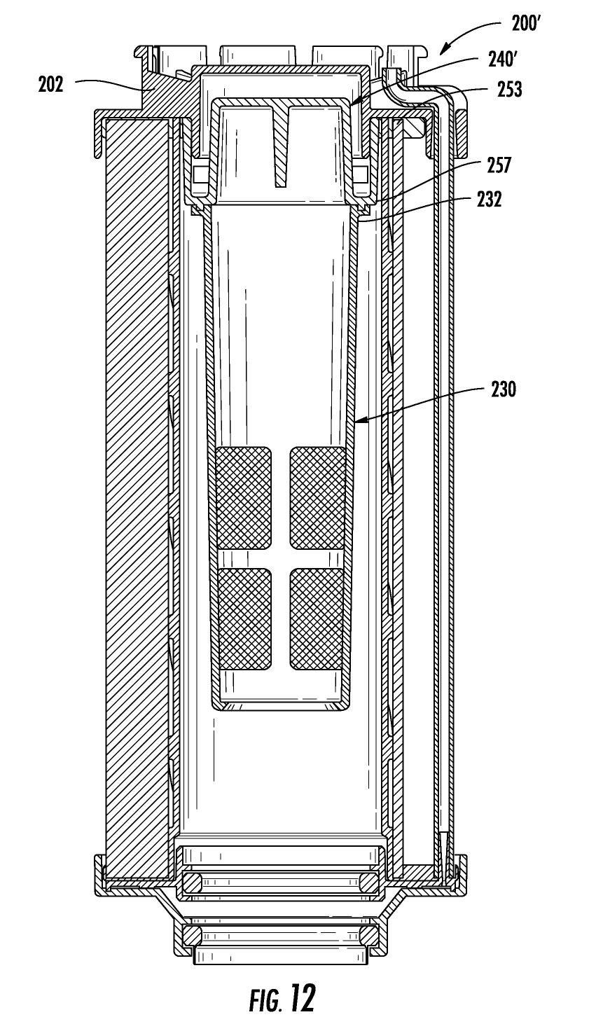

FIGS. 12 and 14 illustrate an alternative embodiment of a filter element 200′ according to the disclosure. Discussion of filter element 200′ will focus on where this embodiment differs from filter element 10, 100, and 200 discussed above. Filter element 200′ includes an axial spacer 240′ extends from an outer lip 253 to a lower annulus 257. The outer lip 253 is potted to the upper end cap 202 and the lower annulus 257 is connected to the upper end 232 of the separator tube 230. The pin 237 extends from the radial disc 246′ which is transversely disposed within the axial spacer 240′. An outer wall 256 extends from the outer lip 253 to the lower annulus 257 and an inner wall 258 extends from the lower annulus 257 to the radial disc 246′. The inner wall 258 is entirely solid so that no fluid can pass through either wall.

FIG. 15 depicts an alternative embodiment in which grommets 52′ and 54′ are retained in U-shaped grooves of lower end cap 14′ and bottom plate 56′, respectively. Axial grommet 54′ contains an integrated radial skirt 55 extending away from the bottom plate 56′.

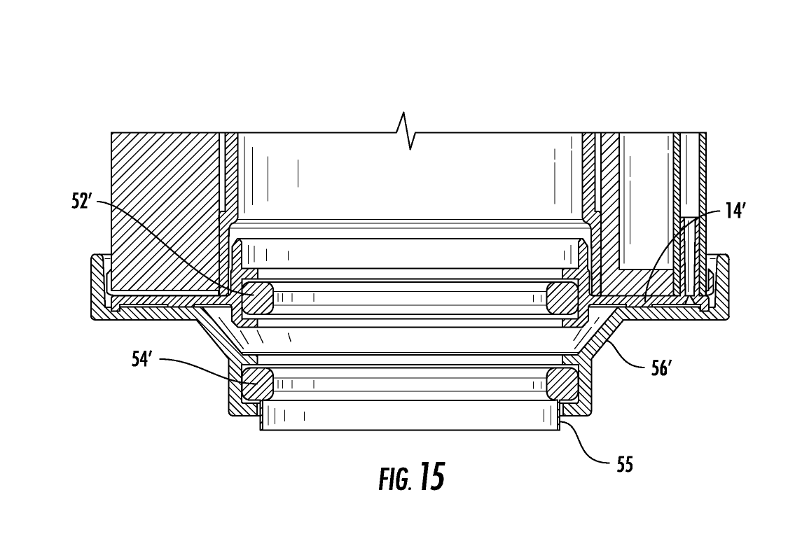

FIGS. 16 and 19 depict an alternative embodiment of filter element 300 according to the disclosure. Discussion of filter element 300 will focus on where this embodiment differs from filter element 10, 100, 200, and 200′ discussed above. Referring to FIG. 16, filter element 300 contains a single grommet 352 that is axially trapped between bottom plate 356 and lower end cap 314. In this embodiment, the lower end cap 314 contains a cap retention shoulder 359 and a top circumferential flange 363. A bottom circumferential flange 365 extends from the bottom plate 356 towards the lower end cap 314 and a plate retention shoulder 366 provides a lower axial limit for single grommet 352.

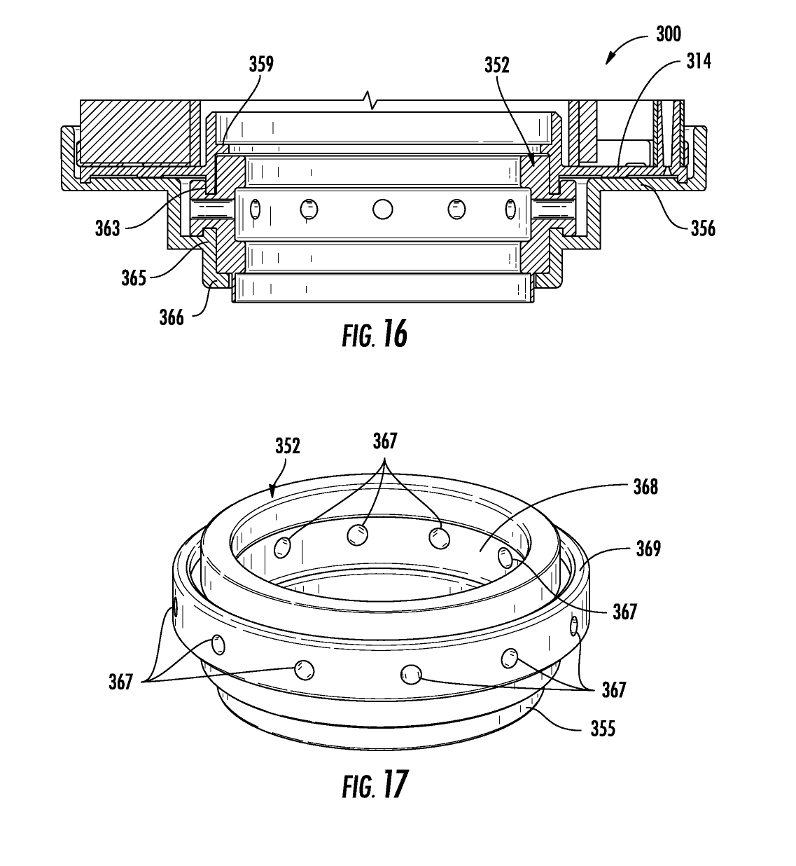

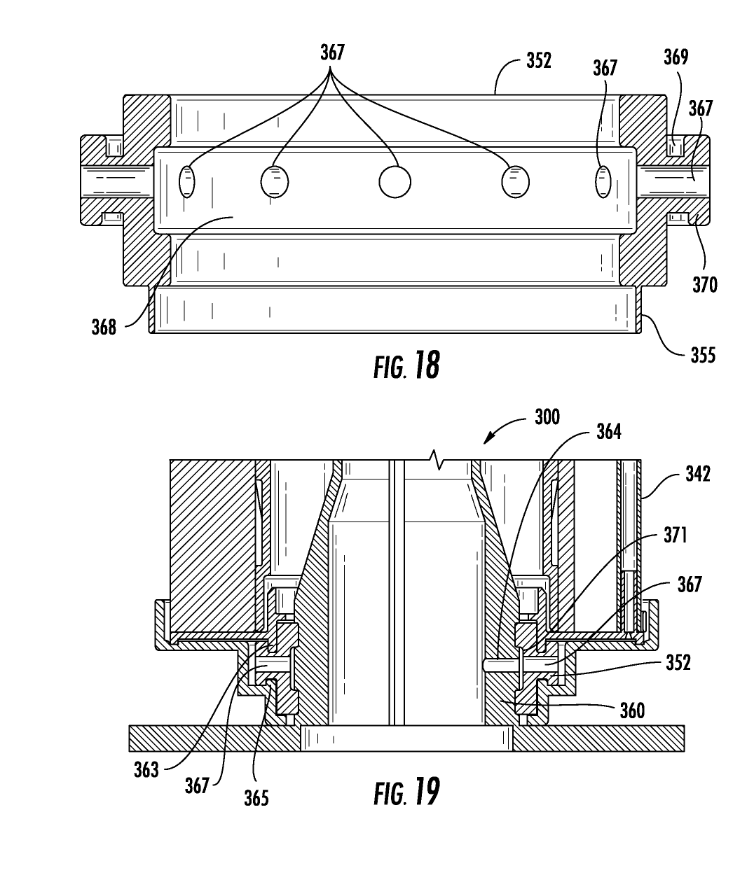

The single grommet 352 is depicted in greater detail in FIGS. 17 and 18. The single grommet 352 contains a plurality of bypass holes 367 disposed in the sidewall 368 between upper and lower grooves 369, 370. The bypass holes 367 extend through the single grommet 352 and are circumferentially spaced about the sidewall 368.

The circumferential flanges 363, 365 engage the upper and lower grooves 369, 370, respectively, of the single grommet 352 to retain the single grommet 352 in radial position. The cap retention shoulder 359 cooperates with the plate retention shoulder 366 to retain the single grommet 352 in axial position. An integral radial skirt 355 extends from the bottom end of single grommet 352 away from bottom plate 356.

Referring to FIG. 19, a narrow dispersion chamber 371 is formed between the single grommet 352 and the standpipe 360 connecting the plurality of bypass holes to one another. The bypass holes 367 and dispersion chamber 371 create a fluid flow path from the duct 342 to the drainage hole 364 in a similar manner to the flow path created between grommets 52, 54 and 52′, 54′ as described in the alternate embodiments above.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What we claim is:

1. A filter element comprising:
an outer filter having a first filter medium that separates particulates from a fluid surrounding a center tube, said center tube including holes spaced about said center tube;
an inner filter having a separator tube containing a frame and a pin extending from a transverse surface of said separator tube radially inward of said inner filter, said frame supporting a second filter medium that separates water droplets from said fluid; and
a duct defining a fluid passage disposed radially outwards of said center tube;
wherein said outer filter is axially fixed at opposite ends by an upper end cap and a lower end cap, said upper end cap includes an aperture extending entirely through said upper end cap in an axial direction, said duct is disposed in said aperture and provides a fluid flow path from above the upper end cap to a fluid reservoir below said lower end cap, and said pin extends in the axial direction towards said lower end cap.

2. The filter element of claim 1, wherein said first medium is a pleated structure and said fluid passage is disposed between adjacent pleats, radially outside of said first filter medium.

3. The filter element of claim 1, wherein said inner filter is axially fixed to said upper end cap and said inner filter is axially fixed to said lower end cap.

4. The filter element of claim 1, wherein said fluid reservoir is disposed between said lower end cap and a bottom plate and said lower end cap and said bottom plate each contain a central opening defined by a grommet.

5. The filter element of claim 4, further comprising an annular cradle defined at an inner diameter by a flange extending axially from said lower end plate, at an outer diameter by said bottom plate, and extending radially along said lower end cap.

6. The filter element of claim 5, wherein said outer filter, said center tube, and said duct are potted within said annular cradle.

7. The filter element of claim 4, wherein said lower end cap further comprises a flow restrictor in said fluid passage that controls the rate of fluid flow through said fluid passage.

8. The filter element of claim 1, wherein said fluid reservoir is disposed between said lower end cap and a bottom plate, said lower end cap and said bottom plate each contain a central opening, and the central opening of said lower end cap and the central opening of said bottom end cap are both defined by a single grommet.

9. The filter element of claim 8, wherein said lower end cap further comprises a flow restrictor in said fluid passage that controls the rate of fluid flow through said fluid passage.

10. The filter element of claim 1, wherein said separator tube further comprises fins extending radially outwards from said separator tube to locate and support said separator tube within said center tube.

11. The filter element of claim 3, wherein said separator tube is potted to said upper end cap.

12. The filter element of claim 3, wherein said separator tube is potted to said lower end cap.

13. The filter element of claim 3, wherein said lower end cap further comprises a lip extending radially inwards from an upper end of said lower end cap and said separator tube further comprises a lower flange extending radially outwards from a lower end of said separator tube.

14. The filter element of claim 13, wherein said lower flange further comprises at least one through hole.

15. The filter element of claim 13, wherein said lower flange further comprises a plurality of supports and a plurality of through holes.

16. The filter element of claim 1, further comprising an axial spacer that is axially fixed at an upper end to said upper end cap and is axially fixed at a lower end to said separator tube.

17. The filter element of claim 1, further comprising an axial spacer comprising an outer lip and a lower annulus; said axial spacer extending from said outer lip adjacent said upper end cap to a disc.

18. The filter element of claim 17, further comprising an outer wall between said outer lip and said lower annulus and an inner wall between said lower annulus and said disc, wherein said inner wall extends further in the axial direction than said outer wall.

19. A filter assembly comprising:
a housing having a body, a standpipe, a side wall, and a filter element space; said standpipe extending from said body along a longitudinal axis; said side wall surrounding said standpipe and extending from a lower end adjacent said body to an upper end containing mounting threads, and said filter element space extending radially from said standpipe to said side wall;
a cover engaging said side wall at said mounting threads; and
a filter element disposed in said filter element space; said filter element containing an outer filter, an inner filter, a duct defining a fluid passage, an upper end cap, and a lower end cap;
said outer filter has a first filter medium surrounding a center tube, said center tube including holes communicating with an annular space defined between said outer filter and said inner filter;
said inner filter has a separator tube defining a frame and a pin extending from a transverse surface of said separator tube radially inward of said inner filter, said frame supports a second filter medium that separates water droplets from said fluid, and said frame engaging said standpipe; and
said fluid passage is disposed radially outwards of said center tube; and
wherein said outer filter and said duct are axially fixed at opposite ends by an upper end cap and a lower end cap, said upper end cap includes an aperture extending entirely through said upper end cap in an axial direction, said fluid passage extends from above the upper end cap to a fluid reservoir below said lower end cap, said pin extends in the axial direction towards said lower end cap to engage a complementary structure on said standpipe, and said upper end cap engages said cover.

20. A method for replacing a filter element of a filter assembly, comprising the steps of:
removing a filter cover containing a spent filter element from the filter housing, the filter housing having a standpipe extending from a base at a lower end of the filter assembly to a free end at the upper end of the filter assembly, the standpipe cooperates with the spent filter element to define a fluid passage from the upper end of the filter assembly to a low pressure passage through an upper opening on the free end of the standpipe and the spent filter element blocks a fluid passage through a lower opening adjacent the base of the standpipe, said spent filter element remaining with the filter cover when the filter cover is removed from the filter housing and a portion of the fluid passage remaining with the standpipe in the filter housing;
detaching the spent filter element from the filter cover;
inserting a filter element into the filter cover; and
reattaching the filter cover containing the filter element to the filter housing, the filter element having a duct to complete a fluid passage extending from the upper end of the filter assembly to a low pressure passage through the lower opening adjacent the base of the standpipe and the filter element having a pin to block the upper opening on the free end of the standpipe such that the fluid passage through the upper opening in the standpipe is closed to fluid flow.
